(19) United States
(12) Patent Application Publication
(10) Pub. No.: US 2018/0042279 A1
(43) Pub. Date: Feb. 15, 2018

(54) FAT-BASED FLAVOUR CONCENTRATES AND PROCESS FOR PRODUCING SAME

(71) Applicant: NESTEC S.A., Vevey (CH)

(72) Inventors: Josef Kerler, Singapore (SG); Jingcan Sun, Singapore (SG); John Newell, York Yorkshire (GB); Tomas Davidek, Correvon (CH); Ondrej Novotny, Cugy (CH)

(21) Appl. No.: 15/558,232

(22) PCT Filed: Mar. 11, 2016
(86) PCT No.: PCT/EP2016/055362

§ 371 Date: Sep. 14, 2017

(30) Foreign Application Priority Data
Mar. 19, 2015 (EP) 15159892.7

(51) Int. Cl. A23L 27/21; A23L 27/30; A23L 35/00; A23L 29/20; A23L 29/00; A23L 27/20; A23L 2/56

(52) U.S. Cl. CPC A23L 27/215; A23L 27/206; A23L 27/33; A23L 2/56; A23L 29/20; A23L 29/05; A23L 35/10; A23V 2002/00; A23V 2200/15

(57) ABSTRACT

The present invention relates to a process for manufacturing a fat-based flavour concentrate obtained by a thermal reaction wherein the process comprises the step of providing a flavour precursor composition comprising at least one polyol and at least one amino compound comprising amino acids, amino acid derivatives and peptides with a dairy ingredient;followed by heating the flavour precursor composition with the dairy ingredient to generate a fat-based flavour concentrate; and cooling the fat-based flavour concentrate.

### FIELD OF THE INVENTION

The present invention relates to novel fat-based flavour concentrates, its method of preparation as well as its incorporation into beverage products, in particular, creamers for white coffee beverages.

### BACKGROUND OF THE INVENTION

A large number of different flavour characters are associated with coffee beverages, in particular for white coffee beverages. Milky-creamy, biscuit, caramel and body were found to be highly desired characters in consumer studies. In addition, consumers also like the coffee-roasty character to be well perceivable in a white coffee beverage. Current coffee creamers, in particular those containing a low level of dairy components or no dairy ingredients at all, cannot deliver on all or several of above described desired flavour characters.

One approach of developing creamers with the desired flavour characters mentioned above involves their thermal generation in a process step prior to the creamer production process. Such an additional process step aims at preparing a complex flavour concentrate through Maillard reaction that can be incorporated at the wet mix stage into a coffee creamer recipe, followed by spray drying to obtain a creamer powder.

It is known in the art that fat based systems, i.e. using a fat continuous phase in which ingredients/precursors are dispersed, can be used to generate flavours. Such fat based systems are suggested to be more suitable for the preparation of flavour concentrates with sweet-brown tonalities (e.g. biscuit, cooked milk) as compared to aqueous systems. This is due to the fact that food processes that generate such flavour attributes involve drying processes and make use of food recipes that are rich in fat. In addition to the preparation process, fat based flavour concentrates offer good shelf stability in contrast to aqueous systems. State of the art methods are mainly based on heating of fat, often milk fat, together with reducing sugars, proteins and alkaline catalysts in anhydrous or low moisture systems.

For example, EP1411778 discloses a procedure for thermal generation of a special “dulce de leche” (“sweet of milk”) flavour used in fat-based confections. Typical flavours as well as textural attributes are created from three major components: sweetener, dairy protein and fat. Sweetener should be in the range of 1.0% to 80.0% by weight of the “dulce de leche” flavoured fat-based confection. The sweetener and dairy protein are first dispersed in a fat to form a raw confection having a fat continuous phase. The mixture is then heated from 70°-180° C., for 1-1440 minutes to thermally generate one or more flavour components selected from the group consisting of 2-hydroxy-3-methyl-2-cyclopenten-1-one (0.001-30 ppm), 2-acetyl furan (0.001-30 ppm), 2-acetyl-3-hydroxyfuran (0.001-250 ppm) and methyl furanoate (0.001-60 ppm), thereby forming a fat-based confection. The flavour is characterized by dairy main character with a lower caramelized sugar flavour.

In another example, EP1383397 describes a process for the preparation of flavour concentrates used for the manufacture of chocolate, compound chocolate or ice-cream coating. The concentrates are produced by mixing (A) proline, ornithine, or protein hydrolysate, and (B) rhamnose, fructose, or fucose, in a fat-based medium, and heating the mixture to about 100°-140° C. for 10-120 minutes. The compositions contain 4-hydroxy-2,5-dimethyl-3(2H)furanone as the major flavour compound, and further comprise other flavour compounds including 2-hydroxy-3-methyl-2-cyclopentene-1-one. The concentrates impart a caramel and/or biscuit/cookie flavour into confectionary products.

U.S. Pat. No. 4,684,532 and U.S. Pat. No. 4,753,814 describe the use of butter in combination with water, sugar and an alkaline catalyst to produce flavours with a caramel butterscotch flavour. A process for obtaining an aqueous soluble butter flavour is disclosed comprising cooking together an aqueous combination of sugar and butter in a ratio of 50:1 to 1:10 at a temperature of about 150°-250° F. (65°-121° C.) for about 0.5-5 hours. Heating is done in the presence of a base catalyst with the admixture held at a pH of at least 7.0 (U.S. Pat. No. 4,753,814). The resultant emulsion is separated to recover an aqueous phase having a cooked butter flavour (U.S. Pat. No. 4,684,532) or caramel butterscotch flavour (U.S. Pat. No. 4,753,814). When incorporated into low calorie table syrups, the flavour imparts a corresponding taste and maintains the syrup as a clear composition. Low fat spreads may also successfully utilize the recovered cooked butter flavour phase.

The above state of the art flavour concentrates have been developed for application in confectionary products (e.g. chocolate). Since the disclosed flavour profiles of EP1383397 and EP1411778 seemed to potentially meet our needs for creamy-milky, biscuit and caramel flavour signatures in beverages, we have reproduced two versions of flavour concentrates (see Examples 1 and 2, one as per above mentioned patents) and incorporated them into our standard creamer recipe. The resulting creamers have been used to formulate 3in1 coffee beverages (see Table 8). The sensory evaluation of the coffee beverages containing the creamers of Examples 1 and 2 against a reference (using the same standard creamer without any addition of a flavour concentrate) clearly demonstrated that these flavour concentrates developed for confectionary products cannot deliver the desired flavour attributes in a white coffee beverage application. Results shown in Table 9 revealed that:
The creamer containing the dulce-de-leche flavour concentrate (example 1 corresponds to the composition described in EP1411778) enhances only slightly milky-creamy and body characters in the coffee beverage, while the roasty note is perceived at a lower intensity. In addition, a cereal note which can be considered a less desirable character for white coffee applications has been perceived by panellists with a high intensity.
The creamer containing the flavour concentrate of example 2 corresponds to the composition described in EP1383397) clearly enhances biscuit and milky-creamy attributes as well as overall intensity, yet also imparts a less desirable cereal note into the beverage, meaning that the biscuit character is perceived as biscuit-cereal note. In addition, body is also only slightly enhanced and roasty character is decreased.

We can conclude from these examples that the use of state-of-the art flavour concentrates developed for confectionary have only very limited value for coffee based beverages. This is due to the fact that the desired flavour target profile for white coffee beverages of simultaneously having biscuit, milky-creamy, caramel and body attributes, with lowest possible cereal notes and highest possible roasty notes, cannot be met. Undesirable cereal characters are too abundant, while body, milky-creamy and caramel notes are not strong enough. In addition, the roasty, and consequently also coffee character, is masked to some extent.

Hence, a need persists to develop novel flavour concentrates for application in creamers and beverages, particularly white coffee beverages. Such flavour concentrates should impart signature flavour attributes such as milky-creamy and biscuit as well as induce caramel notes and body (complexity, mouthfeel) perception similar to condensed milk, while conserving or even enhancing the roasty character of the beverage. The present invention relates to such novel flavour concentrates.

### SUMMARY OF THE INVENTION

Accordingly, the present invention provides a fat-based flavour concentrate obtained by thermal reaction of a unique combination of dairy ingredients with flavour precursors such as a combination of single amino acids and reducing sugars in a continuous oil phase. In the embodiments of the present invention, the ingredients used to prepare the flavour concentrates comprise:
(a) Amino acids—proline, lysine
(b) Reducing sugars—rhamnose, xylose
(c) Dairy ingredients (containing dairy proteins and lactose as additional reactive sugar)—for example, skim milk powder (SMP) or buttermilk powder (BMP), whey powder or whey permeate

The above core ingredients can be combined with additional amino acids such as arginine, glycine, phenylalanine, leucine and/or iso-leucine, any ammonium salts as well as with additional reducing sugars such as glucose, fructose, arabinose, fucose and/or maltose.

The fat-based flavour concentrates of the present invention exhibit milky, biscuit and caramel characters. When incorporated into a creamer and applied in a white coffee beverage, the said flavour concentrates do not only impart well-balanced milky-creamy, biscuit and caramel characters to the coffee beverage, but also can enhance body (complexity, mouthfeel), and maintain the roasty character of the beverage.

The inventors surprisingly found an optimal combination of specific dairy ingredients with specific amino acids and reducing sugars as well as optimal process conditions, which led to the development of flavour concentrates with desired milky-creamy (condensed milk), caramel, biscuit, body and roasty characters. These novel flavour concentrates are superior in flavour balance as compared to the state-of-the art flavors (see Examples 3-6 referred to as novel flavour concentrates type A-D). Analytical data (see FIGS. 1-3) additionally demonstrate that the thermal reaction of dairy ingredients and specific precursors can enhance yields of lead flavour compounds such as 4-hydroxy-2,5-dimethyl-3(2H)furanone (furaneol), 2,3-butanedione and 2-acetyl-1-pyrroline that exhibit caramel, milky-creamy and biscuit notes. Flavour modulation can be achieved through recipe (i.e. choice of dairy and precursor ingredients) and process (i.e. temperature, time) mastership.

The signature flavour is generated by heating the precursor mix in a continuous oil phase, preferably using hydrogenated palm kernel oil (HPKO), at a low to very low moisture content (<0 to 5% added water). Process conditions involve a temperature range from 90 to 160° C., preferably around 110-125° C., with a residence time ranging between 5 to 30 min, preferably around 10-20 min.

The dairy ingredient/precursor mix is either suspended in the oil continuous phase without any water addition, or the amino acid/sugar mix is pre-dissolved in water together with disodium hydrogen phosphate to allow to dose this aqueous mix in a concentrated form into the suspension of dairy ingredient in oil, i.e. keeping water content in recipe at a very low level (at 5% or lower, preferably lower than 3%). Alternatively, the amino acid/sugar mix can be added in dry format, followed by addition of low amounts of water together with pre-dissolved disodium hydrogen phosphate.

Recipe and process parameters have been optimised in a way that the use of low amounts (i.e. <1%) of reactive sugars such as rhamnose and/or xylose, both alone and in combination is sufficient to achieve high flavour intensity. Surprisingly, the use of these sugars, in particular the use of low levels of xylose in combination with rhamnose, proline and lysine (see example 4A), gives rise to the generation of biscuit and caramel notes that positively impact on the perception of the roasty character, which can also positively impact on coffeeness perception in the final beverage.

Furthermore, the thermal reaction of a dairy ingredient, in particular buttermilk powder (BMP), with a single amino acid such as lysinc, or a mixture of amino acids such as lysinc and prolinc (without the use of additionally added reducing sugars, see Example 5) gives rise to intense milky-creamy like flavour signatures. It has surprisingly been found that buttermilk powder is a key dairy ingredient for the generation of intense milky-creamy character (i.e. compare flavour concentrates type C and D (contain BMP) vs. type A and B (contain SMP)) although its chemical composition is close to skim milk powder.

In one aspect, the present invention relates to a process for manufacturing a fat-based flavour concentrate yielding a caramel and/or biscuit profile obtained by a thermal reaction wherein the process comprises a fat base ranging from 40 to 62% w/w and further providing a flavour precursor composition comprising:
at least one added polyol ranging from 0.25 to 2% w/w (preferably 0.5 to 1%);
at least one added amino compound comprising amino acids ranging from 1 to 4% w/w; and
a dairy ingredient ranging from 35-48%,
wherein the ratio between added polyols and added amino acid compounds rages between 1:4 to 1:8 and the ratio between added precursors (sum of polyols+amino acids) and milk ingredient ranges between 1:8 to 1:10.
heating the flavour precursor composition with the dairy ingredient to generate a fat-based flavour concentrate; and
cooling the fat-based flavour concentrate.

In another aspect, the present invention relates to the above described method, wherein the precursor composition is either suspended in the oil continuous phase without any water addition;

or

the amino acid/sugar mix is pre-dissolved in water together with disodium phosphate to allow to dose this aqueous mix in a concentrated form into the suspension of dairy ingredient in oil, i.e. keeping water content in recipe at a very low level (at 5% or lower, preferably lower than 3%); or

the amino acid/sugar mix can be added in dry format, followed by addition of low amounts of water together with pre-dissolved disodium hydrogen phosphate ranging in amounts from 0.15 to 0.5% w/w.

### BRIEF DESCRIPTION OF FIGURES

FIG. 1: Contents (ppm) of 2,3-butanedione in oil based flavour concentrate dulce-de-leche (example 1 corresponds to composition described in EP1411778); example 2 corresponds to composition described in EP1383397; flavour concentrate type A (example 3).

FIG. 2: Contents (ppm) of furaneol in oil based flavour concentrate dulce-de-leche (example 1 corresponds to composition described in EP1411778); example 2 corresponds to composition described in EP1383397; flavour concentrate type A (example 3).

FIG. 3: Contents (ppm) of maltol in oil based flavour concentrate dulce-de-leche (example 1 corresponds to composition described in EP1411778); example 2 corresponds to composition described in EP1383397; flavour concentrate type A (example 3).

FIG. 4: Contents (ppm) of 2-acetyl furan in oil based flavour concentrate dulce-de-leche (example 1 corresponds to composition described in EP1411778); example 2 corresponds to composition described in EP1383397; flavour concentrate type A (example 3).

FIG. 5: Contents (ppm) of 5-methyl furfural in oil based flavour concentrate dulce-de-leche (example 1 corresponds to composition described in EP1411778); example 2 corresponds to composition described in EP1383397; flavour concentrate type A (example 3).

FIG. 6: Contents (ppm) of 2-acetylpyrroline in oil based flavour concentrate dulce-de-leche (example 1 corresponds to composition described in EP1411778); example 2 corresponds to composition described in EP1383397; flavour concentrate type A (example 3).

FIG. 7: Contents (ppm) of 2,3-butanedione in oil based flavour concentrate flavour concentrates B (example 4A) and B-SMP (example 4B).

FIG. 8: Contents (ppm) of furaneol in oil based flavour concentrate flavour concentrates B (example 4A) and B-SMP (example 4B).

FIG. 9: Contents (ppm) of maltol in oil based flavour concentrate flavour concentrates B (example 4A) and B-SMP (example 4B).

FIG. 10: Contents (ppm) of 2-acetylpyrroline in oil based flavour concentrate flavour concentrates B (example 4A) and B-SMP (example 4B).

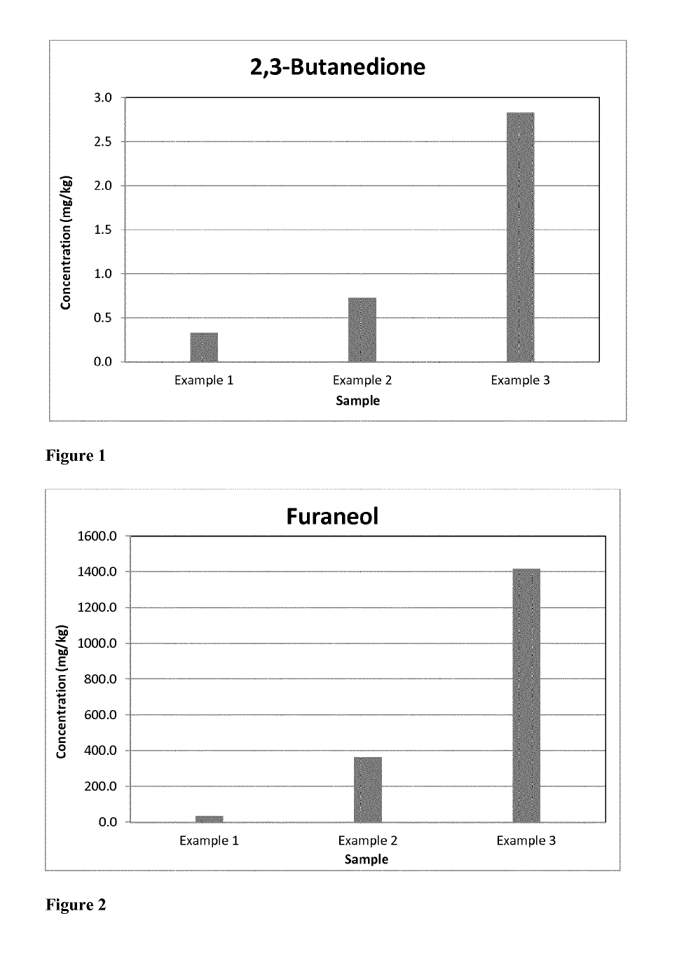

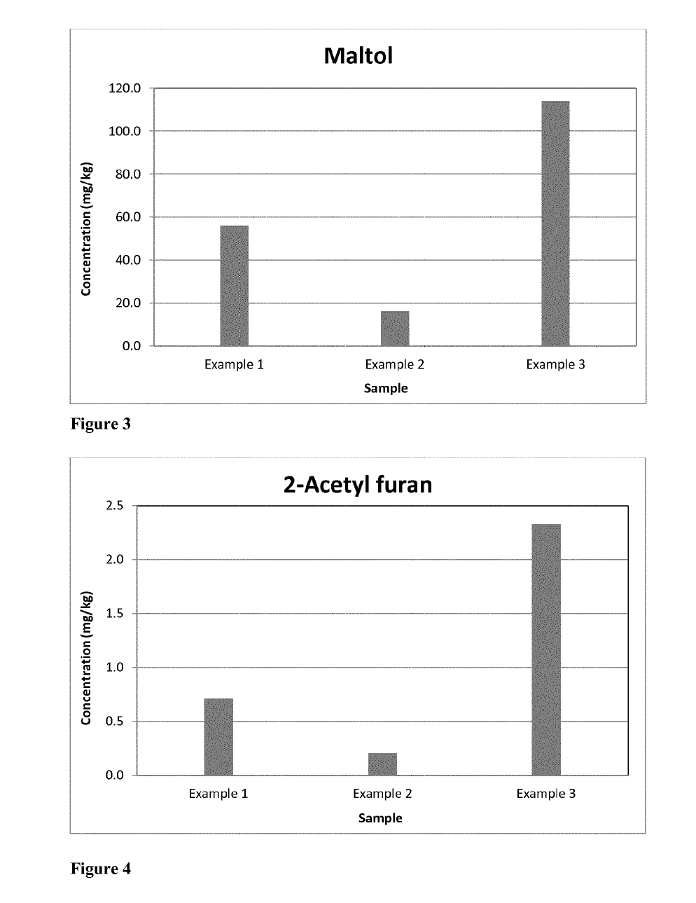

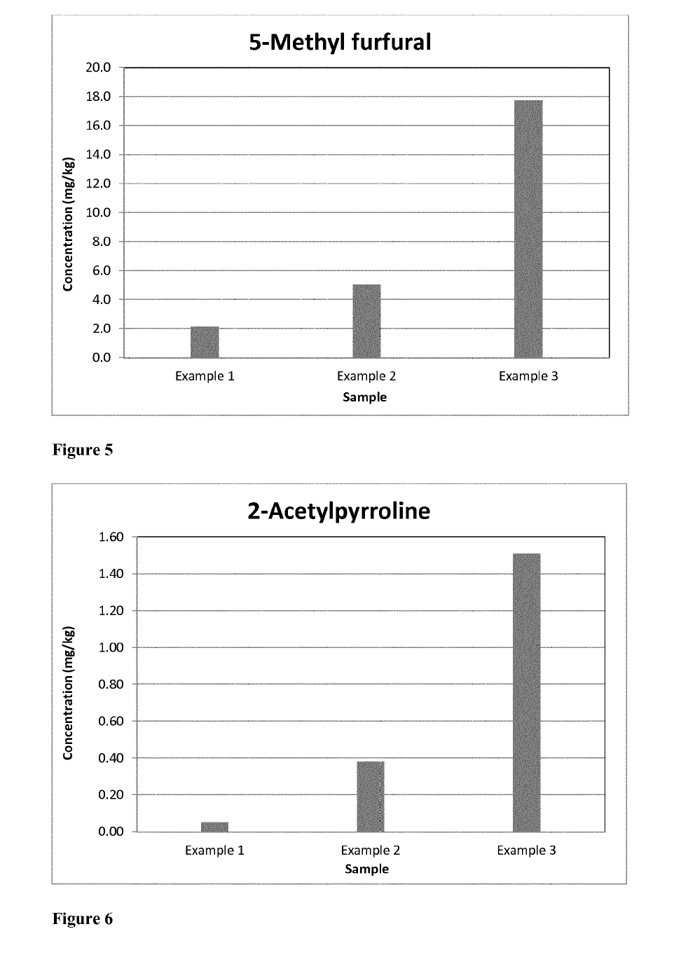

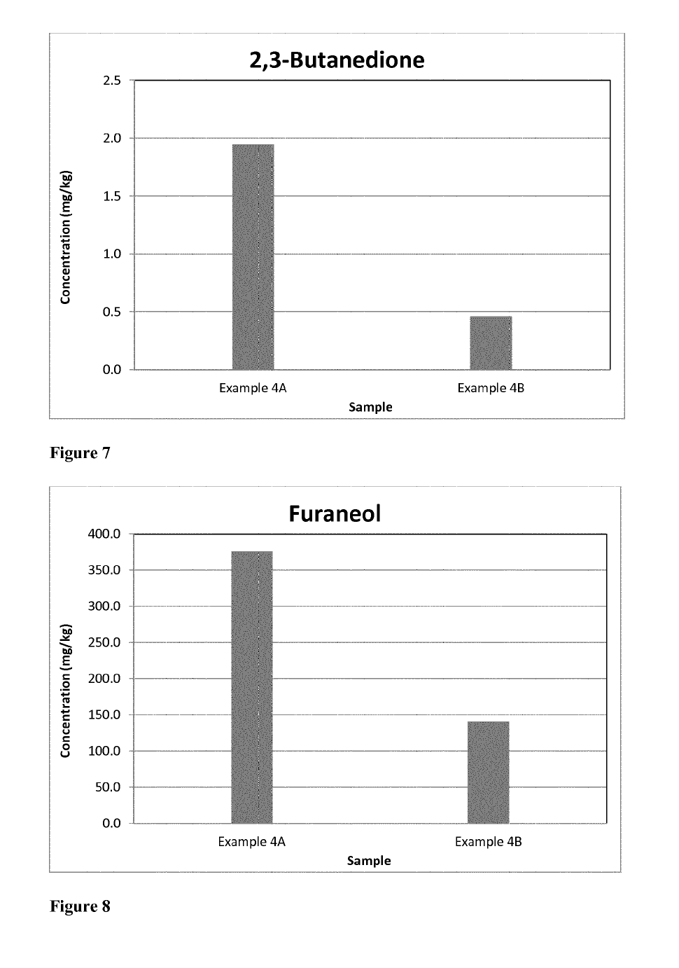

### DETAILED DESCRIPTION OF THE INVENTION

In the present invention, “fat-based” refers to a material having a fat/lipid continuous phase in which material components such as milk ingredients and sugars/amino acids are dispersed. The amino acids used for the present invention can be any amino acid. Most preferably this amino acid is proline or lysine. Proline was used as amine flavour precursor, as proline is a precursor for biscuit/bread/roast type aroma compounds as well as it can also catalyse the generation of caramel flavour. Lysine, alone or in combination with proline, was used to catalyse the formation of caramel and milky-creamy notes. The preferred use levels (% of solid content of flavour concentrate premix) of these amino acids range from 0.25 to 2.5% for proline and 0.5 to 5% for lysine.

The reducing sugar used for the reaction step can be any mono—or disaccharide. Examples of reducing sugars are lactose, maltose, dextrose, fructose, rhamnose, fucose, xylose, arabinose, and combinations thereof. Preferably, the reactive sugar used in our embodiments is rhamnose and/or xylose in the range up to 5% (% of solid content of flavour concentrate premix, preferably in the range below 1%).

The inventors have found that the use of xylose in combination with rhamnose at low levels (sum of both sugars at 1% and lower) as well as with proline and lysine was able to maintain roasty characters at the same level as in the reference 3in1 beverage.

Any fat is suitable for use in the present invention as long as it is heat stable. Exemplary fats include, without limitation and in their low moisture form if applicable, fractionated palm kernel oil, cocoa butter, anhydrous milk fat (AMF), hydrogenated vegetable oil such as soy fat or cottonseed oil, and combinations thereof. Hydrogenated palm kernel oil (HPKO) is preferably used in the flavour concentrate. The fat/oil serves as continuous phase and levels range from 20 to 98%, preferably from 35 to 55%, even more preferably from 40 to 50%. Hydrogenated palm kernel oil (HPKO) comes from the kernel or seed of the oil palm plant. It is distinguished from palm oil, which is sourced from the fruity flesh of the oil palm. HPKO has a fat composition that resembles coconut oil, in which 90-95% of its fat content is saturated fat. The saturated fat in HPKO is comprised mostly of lauric acid, and it is often used in margarine, shortenings, puff pastries, and for frying at high temperatures.

Likewise, any dairy ingredient is suitable for use in the present invention as long as it has low moisture content. Examples of such dairy ingredients include, without limitation, non-fat dry milk (i.e. skim milk powder), sweet buttermilk powder, demineralized whey powder, whey permeate, whole milk powder and combinations thereof. Dairy ingredient levels range from 1 to 60% (% of solid content of flavour concentrate premix), preferably from 30 to 55%, more preferably from 40-55%.

Heat treatment processes that can be used to generate the flavour concentrates involve batch cooking or the use of heat exchangers in case of continuous processing.

The following molecules were identified as key aroma compounds of the flavour concentrates that are part of this invention (concentration ranges (in ppm) that were analysed in flavour concentrates of examples 3 and 7 in brackets): 2,3-butanedione (1.95-2.83 ppm), 4-hydroxy-2,5-dimethyl-3(2H)furanone (furaneol; 376-1417 ppm), sum of 2-acetyl-1-pyrroline and 2-propyonyl-1-pyrroline (1.36-1.55 ppm). The flavour concentrates of this invention, which involve a combined thermal processing of dairy ingredient and reactive sugars/amino acids, surprisingly give rise to higher yields in key aroma compounds as compared to the same recipes without skim milk powder (see comparison of data (ppm) in FIG. 2 of examples 4 and 7 vs. examples 2 and 8). The only exception is the content of pyrrolines (i.e. sum of 2-acetyl-1-pyrroline and 2-propyonyl-1-pyrroline) which is higher in example 8 vs. example 7. Results in FIG. 2 can, in addition to the sensory results, demonstrate that a more efficient flavour generation system could be developed relative to existing processes of e.g. examples 1 and 2 (i.e. could further optimise existing flavour concentrates from both a recipe and process point of view). It also demonstrated the uniqueness of reacting dairy ingredients together with reactive sugars and amino acids.

The surprising finding that the flavour concentrates of this invention (as part of a creamer) can enhance the body (complexity, mouthfeel) of white coffee beverages should also be a result of the higher flavour yields.

The flavour concentrates of this invention can be used as an ingredient in the manufacture of creamers for coffee based beverages. The flavour concentrate is incorporated into a creamer wet mix having a composition as described in Table 5, followed by drying, preferably spray drying, to produce a creamer powder. The dosage of the flavour concentrates in the creamer recipe ranges from 4% to 50% of the dry matter of creamer mix, more preferably from 12% to 40%. The resulting creamer containing the flavour concentrates is typically dosed at 30% to 50% in the coffee mix recipe.

The remaining components of the creamer powder may be standard or conventional. Ordinarily, the remaining components include one or more proteins, fats, and carbohydrates forming sweeteners or bulking agents. The amounts of these components may vary depending upon the desired characteristics of the creamer powder.

For example, the creamer powder may contain emulsifiers such as lecithin, Panodan and monoglyceride Dimodan, proteins such as sodium caseinate, fats such as hydrogenated palm kernel oil, carbohydrates such as maltodextrin DE 24-29, pH regulators such as trisodium citrate, sodium hexametaphosphate and trisodium phosphate as well as minor amounts of sodium chloride.

The creamer powder containing the flavour concentrate may be produced by any suitable technique. For example, the creamer powder is produced from a wet mix of above mentioned ingredients including one of the flavour concentrates. This creamer wet mix with a solid content of 40% to 70%, preferably between 45% to 65%, is upon homogenization and pasteurization transformed into a powder through conventional spray drying.

The creamer powder thus obtained may then be mixed with a soluble coffee powder and sugar to provide a soluble coffee beverage product. The soluble coffee powder may be any spray- or freeze-dried coffee powder.

In one embodiment, the present invention relates to a process of obtaining a beverage composition, for example coffee mixes, cocoa and malt beverages.

In one embodiment, the present invention relates to a process of obtaining a flavor concentrate for example a creamer with the flavor concentrate.

### EXAMPLE 1

### Preparation of Dulce De Leche Flavour Concentrate (Comparative Example 1)

In close accordance to example 1 of EP1411778, a dulce-de-leche type of flavour concentrate was prepared by melting hydrogenated palm kernel oil at 75° C. (product temperature) and subsequent mixing with the dry ingredients listed in Table 1 using an agitated pressure cooker (Stephan mixer). The ingredient mix was then heated to 120° C. (within 5-10 min.) and held for 10 minutes using a steam-jacketed Stephan mixer equipped with high speed stirrer (Note that holding time of 10 min was chosen to be directly comparable to the flavour concentrates obtained in this invention). The finished dulce de leche fat-based flavour concentrate was then cooled to 70° C. prior to incorporation into the wet mix of a creamer base (see Example 7).

TABLE 1
Composition (%) of ingredients for the preparation
of the dulce-de-leche flavour concentrate

| Ingredients | % raw material (dry) |
|---|---|
| Sugar | 44.47 |
| Hydrogenated palm kernel oil | 35.00 |
| Skimmed milk powder | 19.24 |
| Lecithin | 0.475 |

### EXAMPLE 2

### Preparation of Nestle Flavour Concentrate (Comparative Example 2)

In close accordance to example 1 of EP1383397, a flavour concentrate was prepared by melting hydrogenated palm kernel oil at 75° C. (product temperature) and subsequent mixing with lecithin as well as with the dry rhamnose, proline and disodium phosphate in amounts shown in Table 2 (Note that recipe and process conditions of EP1383397 were chosen to be directly comparable to the flavour concentrate obtained in this invention as well as to EP1661465). Using a steam-jacketed Stephan mixer equipped with high speed stirrer, the ingredient mix in oil was then heated to 115° C. (within 5-10 min.) and held for 10 minutes. The finished biscuit-popcorn smelling fat-based flavour concentrate was then cooled to 70° C. prior to incorporation into the wet mix of a creamer base (see Example 7).

TABLE 2
Composition (%) of ingredients for the preparation
of the Nestlè flavour concentrate

| Ingredients | % raw material (dry) |
|---|---|
| Hydrogenated palm kernel oil | 96.76 |
| Proline | 1.44 |
| Rhamnose | 0.92 |
| Lecithin | 0.475 |
| Disodium phosphate | 0.28 |

### EXAMPLE 3

### Preparation of a Novel Flavour Concentrate A for Beverages

A novel flavour concentrate type A was prepared by melting hydrogenated palm kernel oil at 75° C. (product temperature) and subsequent mixing with lecithin. Then, the dry ingredients shown in Table 3 were suspended into the oil, in a first step the skim milk powder, and in a second step the premix of all other precursor materials. Using a steam-jacketed Stephan mixer equipped with high speed stirrer, the ingredient mix in oil was then heated to 115° C. (within 5-10 min) and held for 10 minutes. The finished caramel-biscuit smelling fat-based flavour concentrate was then cooled to 70° C. prior to incorporation into the wet mix of a creamer base (see Example 7).

TABLE 3
Composition (%) of ingredients for the preparation
of the flavour concentrate A of this invention

| Ingredients | % raw material (dry) |
|---|---|
| Hydrogenated palm kernel oil | 50.00 |
| Skimmed milk powder | 44.6 |
| Lysine HCl | 2.28 |
| Proline | 1.44 |
| Rhamnose | 0.95 |
| Lecithin | 0.475 |
| Disodium phosphate | 0.28 |

### EXAMPLE 4A

### Preparation of a Novel Flavour Concentrate B for Beverage

A novel flavour concentrate type B was prepared by melting hydrogenated palm kernel oil at 75° C. (product temperature) and subsequent mixing with lecithin. Then, the dry ingredients shown in Table 4 were suspended into the oil, in a first step the skim milk powder, and in a second step the premix of all other precursor materials. Using a steam-jacketed Stephan mixer equipped with high speed stirrer, the ingredient mix in oil was then heated to 115° C. (within 5-10 min) and held for 10 minutes. The finished biscuit-roasty smelling fat-based flavour concentrate was then cooled to 70° C. prior to incorporation into the wet mix of a creamer base (see example 5). The flavour concentrate type B differs from type A in terms of the replacement of ca. half of the reactive monosaccharide rhamnose with xylose.

TABLE 4
Composition (%) of ingredients for the preparation
of the flavour concentrate B of this invention

| Ingredients | % raw material (dry) |
|---|---|
| Hydrogenated palm kernel oil | 50.0 |
| Skimmed milk powder | 44.6 |
| Lysine HCl | 2.28 |
| Proline | 1.44 |
| Rhamnose | 0.5 |
| Xylose | 0.45 |
| Lecithin | 0.475 |
| Disodium phosphate | 0.28 |

### EXAMPLE 4B

### Preparation of a Flavour Concentrate B-SMP for Analytical Comparison with Example 4A

A flavour concentrate B-SMP (flavour concentrate B where skim milk powder content has been omitted while increasing HPKO level to 94.6%) has been prepared under the same conditions as described in this example 4 with the purpose of evaluating analytically the impact of SMP on the flavour generation efficiency/yields in view of demonstrating synergistic effects of SMP and added precursors. Note that analytical comparison was done on the flavour concentrates 4A vs. 4B, thus no creamer was prepared from flavour concentrate 4B.

### EXAMPLE 5

### Preparation of a Novel Flavour Concentrate C for Beverage

A novel flavour concentrate type C was prepared by melting hydrogenated palm kernel oil at 75° C. (product temperature) and subsequent mixing with lecithin. Then, the dry ingredients shown in Table 5 were suspended into the oil, in a first step the buttermilk plus skim milk powder, and in a second step the premix of all other precursor materials. Using a steam-jacketed Stephan mixer equipped with high speed stirrer, the ingredient mix in oil was then heated to 120° C. (within 5-10 min) and held for 10 minutes. The finished milky-creamy smelling fat-based flavour concentrate was then cooled to 70° C. prior to incorporation into the wet mix of a creamer base (see example 7). The flavour concentrate type C differs from type A and B in terms of use of buttermilk powder as dairy ingredient as well as omission of precursors rhamnose, xylose and proline in the recipe.

TABLE 5
Composition (%) of ingredients for the preparation
of the flavour concentrate C of this invention

| Ingredients | % raw material (dry) |
|---|---|
| Hydrogenated palm kernel oil | 50.0 |
| Buttermilk powder | 35.5 |
| Skimmed milk powder | 10.0 |
| Lysine HCl | 3.75 |
| Lecithin | 0.475 |
| Disodium phosphate | 0.28 |

### EXAMPLE 6

### Preparation of a Novel Flavour Concentrate D for Beverage

A novel flavour concentrate type D was prepared by melting hydrogenated palm kernel oil at 75° C. (product temperature) and subsequent mixing with lecithin. Then, the dry ingredients shown in Table 6 were suspended into the oil, in a first step the buttermilk plus skim milk powder, and in a second step the premix of all other precursor materials. Using a steam-jacketed Stephan mixer equipped with high speed stirrer, the ingredient mix in oil was then heated to 115° C. (within 5-10 min) and held for 10 minutes. The finished biscuit-roasty smelling fat-based flavour concentrate was then cooled to 70° C. prior to incorporation into the wet mix of a creamer base (see example 7). The flavour concentrate type D differs from type C in terms of use of additional use of rhamnose in the recipe.

TABLE 6
Composition (%) of ingredients for the preparation
of the flavour concentrate D of this invention

| Ingredients | % raw material (dry) |
|---|---|
| Hydrogenated palm kernel oil | 50.0 |
| Buttermilk powder | 34.75 |
| Skimmed milk powder | 9.8 |
| Rhamnose | 0.95 |
| Lysine HCl | 3.75 |
| Lecithin | 0.475 |
| Disodium phosphate | 0.28 |

### EXAMPLE 7

### Preparation of Creamers with Flavour Concentrates

Coffee creamers were prepared from each of the flavour concentrates obtained in examples 1-6. Flavour concentrates were incorporated into the creamer wet mix as part of the oil stream, i.e. they were premixed with additional hydrogenated palm kernel oil (for flavour concentrates of examples 1 and 3, 4A, 5 and 6) and emulsifiers panodan and dimodan at 65° C. The flavour concentrates were dosed in a way that overall fat content of the creamers were kept constant at 34% of the total solids.

The creamer wet mix preparation (see Table 7 for detailed ingredient quantities) started with moisturing/dissolution of sodium caseinate plus salts (i.e. buffer salts and sodium chloride) in water of 65° C. for 15 min. while stirring at high speed, followed by incorporation of the oil stream (containing the flavour concentrate) and the glucose syrup while stirring at lower speed for another 10 and 5 min., respectively. This premix having a Ts of ca. 50% was then homogenised, pasteurised and spray dried to produce a creamer powder to reach a target Ts of 97-98%.

TABLE 7
Creamer recipes with flavour concentrates
from examples 1-6 of this invention

| | Type of flavour concentrate | |
|---|---|---|
| | Examples 1, 3, | |
| Creamer Ingredients | 4A, 5, 6 | Example 2 |
| Water | 31.95 | 24.44 |
| Sodium caseinate powder | 0.60 | 0.60 |
| Trisodium Citrate INS331iii | 0.185 | 0.185 |
| Sodium Hexametaphosphate INS340 | 0.164 | 0.164 |
| Di-Potassium Phosphate INS340 | 0.314 | 0.314 |
| Salt NaCl | 0.052 | 0.052 |
| Flavour concentrate | 12.00 | 8.78* |
| Hydrogenated palm kernel oil | 4.30 | |
| Emulsifier Panodan 165 INS472e | 0.025 | 0.025 |
| Monoglyceride Dimodan HP INS471 | 0.100 | 0.100 |
| Glucose syrup DE 24-29, Ts 76% | 18.70 | 18.70 |

Footnote to Table 7:
*Note:
The lower dosage of flavour concentrate in the creamer is required to keep fat content of the creamers at the same level (has higher relative fat content due to lower solids content)

### EXAMPLE 8

### Sensory Evaluations

Sensory evaluation of white coffee beverages comprising a mix of soluble coffee, creamers and sugar (so-called 3in1 mixes) was performed by a 6-membered trained panel. Note that creamer with flavour concentrate ex. example 1 was 2-times dosed higher to reach similar skim milk powder content in the 3in1 mix. The reference 3in1 mix was composed of 1.4 g of soluble coffee, 6 g of base creamer and 10 g of sugar.

TABLE 8
Composition of white coffee beverages for sensory evaluations

| | Quantity (g per serve) per prototype | | | | | |
|---|---|---|---|---|---|---|
| | Exam- | Exam- | Exam- | Exam- | Exam- | Exam- |
| Ingredients | ple 1 | ple 2 | ple 3 | ple 4A | ple 5 | ple 6 |
| soluble coffee | 1.4 | 1.4 | 1.4 | 1.4 | 1.4 | 1.4 |
| base creamer | | 3.0 | 3.0 | 3.0 | 1.5 | 1.5 |
| Sugar | 8.5* | 10 | 10 | 10 | 10 | 10 |
| Creamer with | 6 | 3.0 | 3.0 | 3.0 | 4.5 | 4.5 |
| flavour | | | | | | |
| concentrate | | | | | | |

*Footnote to Table 8:
Sugar is dosed lower in 3in1 mix of Example 1 as Flavour concentrate contains sugar (overall sugar content is same for all prototypes)

The products were dissolved in hot water (80° C.) and evaluated coded and in random order by means of a monadic profiling methodology, i.e. panellists were asked to rate defined attributes (see Table 9) on a scale from 0 (absent) to 5 (very high). Results shown in Table 9 involve mean values of two tasting sessions.

TABLE 9
Results of monadic profiling of White Coffee beverages

| | samples | | | | | | |
|---|---|---|---|---|---|---|---|
| Sensory attributes | Reference | Example 1 | Example 2 | Example 3 | Example 4A | Example 5 | Example 6 |
| overall intensity | 2.8 | 2.7 | 3.4 | 3.1 | 2.7 | 3.3 | 3.7 |
| milky-creamy | 1.3 | 1.6 | 2.3 | 2.5 | 2.2 | 3.7 | 3.0 |
| biscuity | 0.5 | 0.5 | 2.5 | 2.7 | 1.9 | 0.7 | 0.9 |
| cereal | 0.3 | 2.8 | 3.0 | 1.6 | 0.7 | 1.7 | 1.7 |
| caramel | 1.2 | 0.0 | 1.0 | 3.0 | 2.0 | 1.0 | 3.7 |
| roasty | 2.5 | 1.5 | 1.8 | 2.1 | 2.5 | 1.7 | 1.8 |
| nutty | 1.5 | 1.8 | 2.3 | 1.2 | 1.5 | 1.0 | 1.3 |
| body | 1.5 | 1.9 | 1.8 | 2.8 | 2.8 | 1.0 | 2.3 |

Results of the sensory evaluation revealed that samples of this invention (i.e. examples 3, 4A, 5 and 6) exhibit more intense milky-creamy (esp. examples 5 and 6), caramel (esp. examples 3 and 6) and body (examples 3, 4A and 6) character, while showing also intense biscuit and roasty notes (esp. examples 3 and 4A). Although the 3in1 with flavour concentrate of example 2 shows an intense biscuit character, this note is perceived as cereal (note that in beverages with flavour concentrates of this invention, the cereal note is perceived with significantly lower intensity), which is a less desirable attribute for our applications. It is also important to point out beverage prototypes of examples 3 and 4A, can maintain the roasty character at a similar intensity as compared with the reference.

### EXAMPLE 9

### Analytical Evaluations

Analytical investigations were focused on the analysis of flavour concentrates and, in particular, on the comparison of flavour concentrates of examples 4A and 4B. The purpose of this work was to demonstrate the synergistic effects of skim milk powder (SMP) when co-reacted with precursors such as single sugars and amino acids. To this end, flavour concentrates 4A (containing SMP plus rhamnose, xylose, lysine, proline as precursor mix) and 4B (same recipe as 4A, but without SMP; note that hydrogenated palm kernel oil content was increased from 50% to 94.6%).

The analyses were performed by Head Space Solid Phase Micro Extraction in combination with Gas Chromatography and Mass Spectrometry (HS-SPME-GC/MS). Stable isotope dilution analysis methodology was used to quantify four key aroma compounds which are shown in Table 10. The flavour concentrate (250 mg) was mixed with 7 ml water and suitable amount of isotope-labelled standards, e.g. butanedione-¹³C₄, 4-hydroxy-2,5-dimethyl-3(2H)-furanone-¹³C₂, 2-acetyl-1-pyrroline-¹³C₂, and maltol-d₃. The analyses were performed by Head Space Solid Phase Micro Extraction—in 20-ml headspace vial. The quantities of the standards were adjusted to obtain a peak arca ratio of analyte/standard between 0.2 and 5. The vial was closed and the mixture was homogenized by means of a vortex agitator for 5 seconds. For HS-SPME, the incubation (5 min) and extraction (30 min) were performed at 70° C. DVB-CAR-PDMS fibre of 2cm (Supelco) was used for the extraction under agitator speed of 500 rpm. The fibre was injected into a GC-MS instrument and aroma compounds were desorbed at 250° C. for 5 min.

For GC/MS, triple quadrupole mass spectrometer with chemical ionization source was employed (Agilent 7000). Methane was used as a reactant gas. Gas chromatographic separations were achieved on a DB-624-UI column 60 m×0.25 mm i.d., film thickness 1.4 μm (J&W Scientific). Helium was used as a carrier gas with a constant flow of 1.0 ml/min.

The analytes were identified by comparing the retention times and fragmentation patterns with standards. Concentrations of analytes were calculated based on peak areas of analytes and internal standards and the amounts of added internal standards. Recovery and response factors were defined as 1, as physical/chemical properties of analytes and standards are the same.

TABLE 10
Key aroma compounds analysed and their flavour qualities

| Flavour compound | Sensory quality |
|---|---|
| 2,3-butanedione | buttery, milky, creamy |
| 4-hydroxy-2,5-dimethyl-3(2H) furanone | caramel, sweet |
| (furaneol) | |
| 2-acetyl-1-pyrroline | popcorn, biscuit, toasted |
| maltol | Caramel, sweet |

Table 10 summarises the key aroma compounds (and their sensory qualities) that were analysed in the frame of this invention. Compounds were selected based on state of the art scientific knowledge of sweet-brown (i.e. biscuit, caramel, milky) type of flavours.

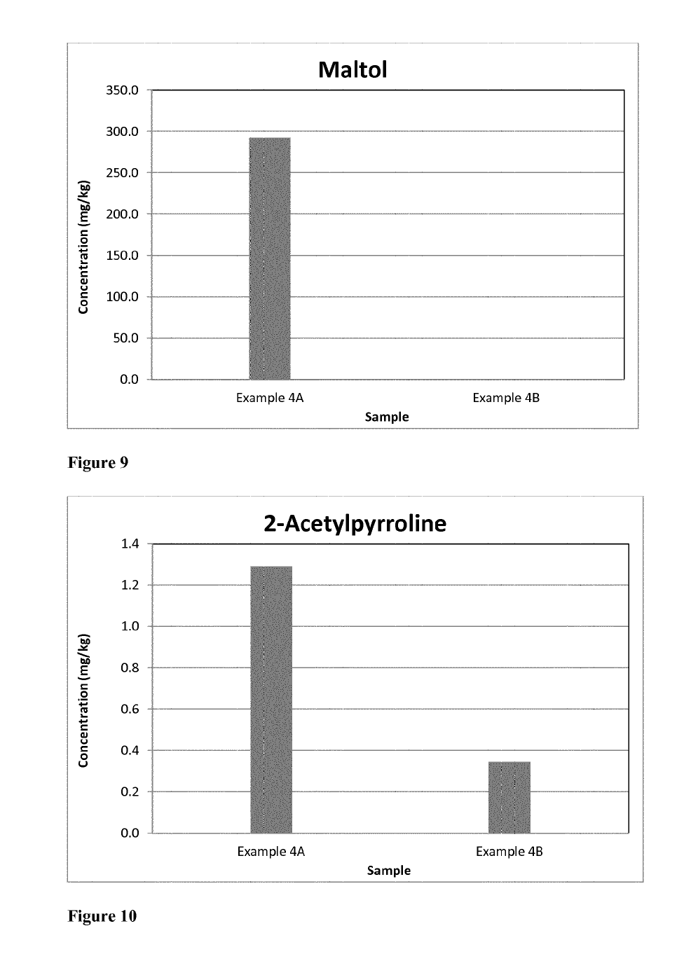

Results (ppb dry matter) flavour concentrate B (example 4A) and B-SMP (example 2B) samples of the quantitative analysis of these key aroma compounds are shown in FIGS. 8-10.

Analytical results revealed that the flavour concentrate B of this invention contains by a factor of 2.6 to 4.2 higher contents of all 4 key aroma compounds. This clearly demonstrates that the recipe and process conditions of this invention were optimised in a manner to improve flavour generation yields. A possible explanation of this surprising finding is that milk ingredients like skim milk powder and precursors like reactive sugars and amino acids act synergistically in terms of the generation of targeted flavour attributes of this invention.

### EXAMPLE 10

### Preparation of Cocoa Malt Beverage with Flavour Concentrate

Cocoa malt beverages were prepared without (example 10A) and with (example 10B) the flavour concentrate type C obtained in example 5. For example 10A, malt extract, skimmed milk powder, sugar, cocoa, palm oil were mixed in a ribbon blender with water to provide a wet mixture. For example 10B, palm oil was replaced with the flavour concentrate type C (which effectively results in the same amount of palm oil as example 10A in the wet mixture, as the flavour concentrate contains 50% hydrogenated palm kernel oil). The mixtures have a solids content of about 89.5% by weight. The composition of the mixtures is given in Table 11 below.

TABLE 11
Cocoa malt beverages recipes without (Example 10A) and with (Example
10B) flavour concentrate from example 5 of this invention

| | Example 10A | Example 10B |
|---|---|---|
| | % raw | % raw |
| Ingredients | material | material |
| PH recipe | % | % |
| Malt Extract Protomalt | 33.5 | 33.5 |
| Sugar White Standard Dry Mix 50 kg | 20.1 | 20.1 |
| Halal | | |
| Milk Skimmed Pwdr MH 25 kg Hal | 24.8 | 24.8 |
| Cooca Powder 10-12% Fat | 5.8 | 5.8 |
| Oil Palm Olein NBD Bulk | 11.4 | 0.0 |
| Flavor Vanillin 25 kg Halal | 0.0 | 0.0 |
| Vulcan Milky Flavour concentrate | 0.0 | 22.9 |

The wet mixtures were then transferred to a vacuum oven which is operated at 120° C. and 25 mbar. The residence in the vacuum oven is about 20 minutes.

The cakes were then crushed and milled to provide powders. The powders preferably have a density of about 500 grams/liter and a size of less than about 2 mm with a broad size distribution.

### EXAMPLE 11

### Sensory Evaluations of Cocoa Malt Beverage with Flavour Concentrate

Sensory evaluation of cocoa malt beverages produced in example 10 was performed by a 9-membered trained panel. The beverages were dissolved in hot water (80° C.) and evaluated by means of a comparative profiling methodology, i.e. panellists were asked to rate defined attributes on a scale from −5 (very much less intense than reference) to +5 (very much more intense than reference). Example 10A in this case serves as the reference.

TABLE 12
Results of comparative profiling of cocoa malt beverages

| | Example 10B |
|---|---|
| Overall Odour | 0.5 |
| Cocoa | 0.0 |
| Malt | −3.0 |
| Cereal | −3.0 |
| Milky | 1.7 |
| Other aroma | 1.0 |
| Overall Flavour | 0.8 |
| Cocoa | 0.4 |
| Malt | −1.5 |
| Cereal | −2.0 |
| Milky | 1.5 |
| Other flavour | 0.7 |
| Sweet | 0.5 |
| Bitter | −1.0 |
| Texture and Mouthfeel | |
| Body | 1.3 |
| Mouthcoating | 1.0 |
| Persistency | 1.0 |
| PH recipe-Milky prototype | |
| Aroma-Milky | 1.8 |
| Flavour-Milky | 2.1 |
| Body | 1.4 |
| Mouthcoating | 2.0 |

Results of the sensory evaluation revealed that the sample of this invention (i.e. example 10B) exhibit higher intensity in milky, body and mouthcoating attributes.

1. Process for manufacturing a fat-based flavour concentrate yielding a caramel and/or biscuit profile obtained by a thermal reaction wherein the process comprises a fat base ranging from 40 to 62% w/w and further providing a flavor precursor composition comprising:
at least one added polyol ranging from 0.25 to 2% w/w (preferably 0.5 to 1%);
at least one added amino compound comprising amino acids ranging from 1 to 4% w/w; and
a dairy ingredient ranging from 35-48%,
wherein the ratio between added polyols and added amino acid compounds is between 1:4 to 1:8 and the ratio between added precursors (sum of polyols+amino acids) and milk ingredient ranges between 1:8 to 1:10;
heating the flavor precursor composition with the dairy ingredient to generate a fat-based flavour concentrate; and
cooling the fat-based flavour concentrate.

2. The process of claim 1, wherein heating step is performed in a continuous oil phase at a low moisture content ranging from 0 to 5% added water.

3. The process of claim 2, wherein oil phase is selected from the group consisting of fractionated palm kernel oil, hydrogenated palm kernel oil cocoa butter, anhydrous milk fat (AMF), hydrogenated vegetable oil, and combinations thereof.

4. The process of claim 3, wherein oil phase is hydrogenated palm kernel oil.

5. The process according to claim 1 wherein the at least one polyol is a reducing sugar.

6. A process according to claim 1 wherein the at least one polyol is selected from the group consisting of glycerol; sorbitol; glucuronic acid; 5-keto-gluconic acid; galacturonic acid; iduronic acid; maltodextrin; glucose syrup; rhamnose; xylose; glucose; fructose; sucrose; lactose; maltose, xylitol, maltitol, erythritol, mannitol and mixtures of these.

7. A process according to claim 1 wherein the at least one polyol is selected from the group consisting of rhamnose, xylose, fructose and combinations of these, and the at least one amino compound is selected from the group consisting of proline, arginine, glycine, lysine and combinations of these.

8. A process according to claim 1 wherein the flavor precursor composition comprises an alkali or acid.

9. The process according to claim 1 wherein the at least one amino compound is selected from the group consisting of glycine, alanine, valine, norvaline, leucine, norleucine, aspartic acid, glutamic acid, asparagine, glutamine, arginine, lysine, serine, threonine, proline, tyrosine, cysteine, cystine, methionine, phenylalanine, histidine, tryptophan, dihydroxyphenylalanine, taurin, thiamine, carnosine and mixtures of these.

10. The process according to claim 1 wherein the at least one polyol is rhamnose and/or xylose and wherein the at least one amino compound is proline or lysine.

11. The process according to claim 1 wherein the dairy ingredient is selected from the group consisting of skim milk powder, buttermilk powder and mixtures of these.

12. The process according to claim 1 wherein the heating is performed at a temperature ranging from 90 to 160° C., with a residence time ranging between 5 to 30 min.

13. The process according to claim 1 wherein a step selected from the group consisting of is used: the precursor composition is either suspended in the oil continuous phase without any water addition;
the amino acid/sugar mix is pre-dissolved in water together with disodium phosphate to allow to dose this aqueous mix in a concentrated form into the suspension of dairy ingredient in oil.
the amino acid/sugar mix can be added in dry format, followed by addition of low amounts of water together with pre-dissolved disodium hydrogen phosphate ranging in amounts from 0.15 to 0.5% w/w.

14. The process according to claim 1 wherein the flavour precursor composition comprises an oil and the process flavor composition is mixed with the aqueous creamer component so as to form an oil-in-water emulsion.

15. A beverage composition obtainable according to the process of claim 1.
